(19) United States
(12) Patent Application Publication
(10) Pub. No.: US 2022/0195686 A1
(43) Pub. Date: Jun. 23, 2022

(54) Anchoring Element

(71) Applicant: RWE Renewables GmbH, Essen (DE)

(72) Inventors: Daniel Bartminn, Elmshorn (DE); Claus Linnemann, Essen (DE)

(21) Appl. No.: 17/604,260

(22) PCT Filed: Feb. 21, 2020
(86) PCT No.: PCT/EP2020/054599

§ 371 Date: Oct. 15, 2021

(30) Foreign Application Priority Data
Apr. 18, 2019 (DE) 10 2019 110 311.8

(51) Int. Cl. E02D 27/42; E02D 27/52

(52) U.S. Cl. CPC E02D 27/425; E02D 2600/30; E02D 27/525

(57) ABSTRACT

In particular, a foundation for an offshore structure is disclosed. The foundation includes: a tower having an anchoring section which is anchorable in the seabed and a connection section arranged at the opposite end of the tower. An electricity generation device arrangable above the water surface is connectable with the connection section of the tower. A natural frequency of the offshore structure is below an excitation from a single revolution number 1P of at least one exciting component. Further disclosed is an offshore structure.

### CROSS-REFERENCE TO RELATED APPLICATIONS

This application is the United States national phase of International Application No. PCT/EP2020/054599 filed Feb. 21, 2020, and claims priority to German Patent Application No. 10 2019 110 311.8 filed Apr. 18, 2019, the disclosures of which are hereby incorporated by reference in their entirety.

### BACKGROUND OF THE INVENTION

### Field of the Invention

The invention relates to a foundation for an offshore structure, and more particularly to an anchoring element comprised by a foundation.

### Description of Related Art

Foundations respectively foundation structures (used synonymously in the following) for offshore structures, in particular offshore wind turbines, are generally designed with regard to their natural frequency in such a way that they do not overlap as far as possible with other frequency excitation bands, e.g. that of the rotor of a turbine as an electricity generation device. In general, in case of a so-called monopile (also referred to as a pile) as the tower of such a wind turbine, a natural frequency f is selected which lies between a 1P and a 3P frequency band, wherein the 1P frequency band corresponds to an excitation from a single rotor revolution number, and the 3P frequency band corresponds to an excitation from three times the revolution number of the rotor of the turbine. In particular, in order to avoid resonant vibrations, an attempt is made to arrange the natural frequency of the offshore structure, e.g., at least 10% above the 1P and below the 3P frequency band. The design of such “stiff” towers or piles of an offshore structure is also called “soft-stiff” design.

In particular, for an application as offshore wind turbines, for example ground foundations (e.g. in the seabed) have been used, with which a natural frequency above the 1P frequency band can be achieved. Other frequency bands of the natural frequency of an offshore wind turbine have so far been avoided for the following reasons:
i) Possible dynamic wave excitation and resulting fatigue loading or resonance of the tower structure of the offshore structure;
ii) In particular, turbines of an offshore wind turbine regularly allow only small tolerances with regard to long-term skewing (e.g. caused by a tidal range of the sea state prevailing in the offshore area); and
iii) Soft structural foundations often contradict standardized verification criteria of geotechnical engineering.

Furthermore, floating foundations for supporting a tower structure of an offshore wind turbine are known, whereby these foundations generally require water depths of more than 20 m, or preferably even more than 40 m. Such floating foundations for use in offshore wind turbines also require complex anchoring systems and flexible floating cable guides.

Sometimes, in waters close to the coast, where a water depth of about 40 m is often not exceeded and which, moreover, do not allow a ground foundation of a tower for an offshore wind turbine, for example, due to a soft ground, and a floating foundation for a tower of an offshore wind turbine due to a lack of water depth, correspondingly can only be made possible by very cost-intensive solutions or, due to this, these have been dispensed.

Today, the foundations and towers of large wind turbines (WT) are typically designed as soft-stiff constructions. For very large offshore wind turbines, however, soft constructions (so-called “soft-soft” constructions) could be of interest in the future, in which the natural frequency is below the excitation frequency (i.e. the rotor and blade passage frequencies).

In particular, one possibility of such soft-soft constructions is to use an anchoring section that is movable even after installation in the seabed.

However, the mobility of such an anchoring section in the seabed also reduces the torsional restraining moment of such soft-soft structures of such foundations compared to conventional foundations that are more firmly anchored in the seabed.

This results in the risk that the structure respectively offshore structure could twist during operation. This is undesirable, e.g. with regard to electrical connection by means of cables, to name just one non-limiting example. Measures to secure the structure against twisting also complicate the installation.

DE 20 2005 004 739 U1 discloses a foundation pile that is loaded predominantly horizontally. The foundation pile consists of an elongated pile body, in particular a tube, with essentially the same cross-section for driving and binding into the subsoil, in particular for a subsoil at least temporarily covered with water.

US 2019/0084183 A1 discloses a wind turbine foundation comprising a concrete support plate having a horizontal reinforcing grid, a concrete base integrally connected to the support plate and having vertical post-tensioning elements, a plurality of concrete ribs on the top of the support plate, the ribs having reinforcing bars and extending outwardly from the base, the base, the plate and the ribs being connected together to form a monolithic foundation.

From WO 2005/038146 A1, a hollow column structurally connected and sealed to a hollow base is known. The hollow column is embedded in the seabed by pumping water from the pedestal. Pumping through the water filter and outlet provides stability to install a pile within the pile meander and embed it with concrete into the foundation. A temporary work platform with pile driving equipment on it can be attached to the platform from which pile driving operations can be performed.

EP 2 441 893 A1 shows a device for supporting a wind turbine for the production of electrical energy in the sea, of the type comprising a base resting on the seabed and a column for supporting said wind turbine connected to the base, said column and said pedestal being interconnected by a linkage allowing inclination movements of said column with respect to said pedestal in all directions with respect to a vertical axis, a rotational joint connecting said column to said pedestal.

### SUMMARY OF THE INVENTION

It would be desirable to be able to provide a solution to minimize or avoid the aforementioned problems, and in particular to be able to increase a torsional restraining moment of such foundations in the seabed without having a lasting effect on the installation.

In view of the background of the presented prior art, it is therefore the present object to at least partially reduce or avoid the described problems, i.e. in particular to provide a cost-effective possibility to be able to found an offshore structure which has an increased torsional restraining moment without having a lasting effect on the installation.

The present object is solved by a foundation according to a first aspect as described herein. The present object is further solved by an offshore structure according to a second aspect, comprising a subject-foundation according to the first aspect.

In the following, some exemplary embodiments are described in more detail according to all aspects:

An offshore structure is, for example, a wind turbine installed offshore. Further, an offshore structure may be, for example, a substation, or a drilling or production platform. An exciting structural element of a wind turbine is typically a rotor blade, or a plurality of rotor blades, comprised by the wind turbine.

Certain offshore structures, in particular wind turbines, are regularly fixed with a foundation in the seabed. A common type of foundation for wind turbines, for example, is a so-called monopile, whereby the tower of the wind turbine extends into the seabed and an anchoring section of the tower is anchored in the seabed. The tower is then fully supported by its anchorage respectively the anchoring section in the seabed.

For the purposes of the present subject-matter, an exciting structural element is understood to mean, in particular, an element which causes the structure and/or the tower to vibrate when the structural element moves. One or more of such vibrations may cause the entire structure, or at least a part thereof, to vibrate in a manner damaging to the structure and/or the tower. This may result in, for example, an at least partial reduction in the strength of the anchorage of the structure in the seabed occurring over a period of time. Furthermore, this can lead, for example, to a torsional force being exerted on the structure (e.g. repeatedly) via the excitation by the structural element, which can subsequently lead to a rotation or twisting of the structure about an axis in the longitudinal extension direction of the structure respectively of a tower of the structure.

In order to be tolerant to strong deflections, and furthermore to be able to resist extreme loads by a large deformability, the foundation must allow a movement of the offshore structure. Offshore structures whose natural frequency is located above the 1P frequency band do not allow this.

In contrast, the present anchoring section of the tower extends less deeply into the seabed, optionally comprising, for example, at least one restoring element in order to ensure tilt stability. This has the effect, for example, in a tilted position of the tower in which the longitudinal extension direction of the tower extends outside a vertically extending axis, that tensile and/or compressive forces are transmitted to the tower by the at least one restoring element, so that the tower is (re)erectable.

The present foundation allows a strong deflection of the tower, wherein a corresponding offshore structure has a natural frequency which is below the 1P frequency band.

For example, the tower has such a length that at least a lower end (e.g. part of the anchoring section) of the tower engages the seabed. For example, the lower end engages the seabed to a lesser depth than is required for a stiff ground foundation (e.g., a conventional ground foundation for a monopile).

The subject-matter is based on the realization that in order to enable the absorption of larger torsional moments without negatively influencing the installation process, the anchoring section of the tower, which is, for example, of cylindrical design, must be structurally modified compared to a conventional geometry. Constructive possibilities for increasing the torsional strength of such offshore structures are realized by one or more anchoring elements which engage in the seabed in such a way that twisting of the offshore structure respectively its tower relative to the seabed is impeded.

For example, the tower comprises a reinforced concrete and/or comprises a steel foundation. Further, the tower may comprise or at least partially comprise, for example, a fiberglass composite material, or a carbon composite material, to name but a few non-limiting examples.

Further, at the anchoring section engaging the seabed, the present foundation comprises one or more anchoring elements that counteract a torsional force about an axis in the longitudinal extension direction of the tower. This reduces or avoids a twisting of the offshore structure relative to the seabed, respectively to a foundation by which the offshore structure is anchored in the seabed.

Consequently, the one or more anchoring elements provide additional resistance to a rotational movement of the tower and/or its foundation in which the anchoring section engages.

A resulting tangentially transferable skin friction stress of the tower respectively anchoring section times the outer surface of the tower or anchoring section is, for example, less than 1.5 times (ideally less than 3 times) the maximum expected and transferable torsional skin friction stresses times the outer surface of the tower respectively anchoring section.

The term “expected skin friction stress” is understood to mean, in particular, a threshold value obtained from a friction between the external and seabed-engaging surface of the tower respectively its anchoring section and this same seabed. For this purpose, for example, an average skin friction stress can be assumed, because in the case of non-cylindrical anchoring sections, the corresponding outer surface of the tower changes. The exemplary factor of 1.5 or 3 guarantees a safety factor against maximum expected twisting. This ensures that an offshore structure will not twist after installation.

Such torsional moments, which can occur, depend in particular on the size of the electricity generation device used (e.g. turbine size), and can, for example, lie in the range of the interval from 50 MNm to 200 MNm for turbines with more than 10 MW, correspondingly higher intervals, if necessary.

For example, the foundation can be dimensioned in such a way that it is determined which torsional moment occurs respectively can occur as a maximum, and which torsional moment the foundation then applies respectively can apply as a maximum counter-moment. The foundation should then, for example, be dimensioned in such a way that it has a tolerance of at least 50% (corresponding to the safety factor 1.5), i.e. at least 50% larger. Ideally, for example, the foundation should be designed to be at least 3 times larger (corresponds to the safety factor 3).

As a reference value, for example, an equivalent outer surface of the tower (e.g. pile outer surface) of a smooth cylinder can be assumed, where the natural torsional stress after insertion of this into the seabed is insufficient, for example, to prevent twisting of the structure. Compared to such a reference value, the above explained dimensioning of 50% can be determined to be up to 3 times larger dimensioning of the foundation.

In an exemplary embodiment of the subject-matter according to all aspects, the anchoring section engaging the seabed comprises an inner anchoring section and an outer anchoring element at least partially enclosing the inner anchoring section, wherein the inner anchoring section is insertable into the outer anchoring element, and wherein one or more torsional forces are transferable from the inner anchoring section to the outer anchoring element.

In an exemplary embodiment of the article according to all aspects, the one or more anchoring elements protrude radially inwardly and/or outwardly from an inner and/or outer surface of the anchoring section.

For example, in the case where the mooring section is at least partially hollow, seabed is also present within the anchoring section after insertion of the anchoring section into the seabed. Accordingly, the one or more anchoring elements may also be arranged internally to ensure more difficult twisting of the offshore structure. In particular, in this case, the one or more anchoring elements also protrude downwardly from the tower (e.g., pile), for example. It will be understood that the one or more anchoring elements may also be arranged externally.

In an exemplary embodiment of the article according to all aspects, the one or more anchoring elements extend substantially in the longitudinal extension direction of the tower beyond the seabed-engaging end of the anchoring section into the seabed.

The one or more anchoring elements are substantially in the direction of the longitudinal extension of the tower within the meaning of the present subject-matter, in particular if they also extend at an angle which is outside a line parallel to the longitudinal extension direction of the tower, but, viewed in the vertical direction, they still extend deeper into the seabed than the deepest end of the anchoring section.

An internal stiffening by means of the one or more anchoring elements from the anchoring section may be implemented, for example, by means of radially arranged plates (e.g. at least three pieces, i.e. at an angle of 120° in the case of three anchoring elements, 90° in the case of four anchoring elements, 72° in the case of five anchoring elements, etc. with respect to each other), which optionally project downwards (i.e. into the seabed) from the anchoring section by a few metres in order to increase the effectiveness. To improve the penetration performance of the foundation when installed in the seabed, the one or more anchoring elements may be, for example, pointed or rounded and so encompassed by or attached to the anchoring section, to name but a few non-limiting examples.

In exemplary embodiments that may be employed by the aforementioned embodiment, for example, the anchoring elements may take the form of thinner piles or comparable profiles, to name but a few non-limiting examples.

Alternatively or additionally, the one or more anchoring elements may be continued or extended in such a way that they form an extension of the anchoring section of the foundation. As already explained, several thinner piles or comparable profiles or bodies which may be attached externally or internally to the anchoring section are suitable in this regard, for example. In the area of an overlap with the main foundation, the thinner piles may be designed in cross-section in such a way that they have a stable connection to the anchoring section, for example via two welds or the like. If these thinner piles are arranged on the inside of the anchoring section, for example, they may also be interconnected.

For example, depending on the nature and method of attachment, the one or more anchoring elements may be arranged only in the lower region of the anchoring section, and/or may further extend downwards towards the seabed (i.e. into the seabed) beyond the lower edge of the anchoring section.

In an exemplary embodiment of the subject-matter according to all aspects, the one or more anchoring elements comprise a reactive material or are filled with a reactive material.

In an exemplary embodiment of the subject matter according to all aspects, the reactive material hardens and/or expands upon water saturation during installation of the foundation.

In an exemplary embodiment of the article according to all aspects, the reactive material expands (e.g., after water saturation) radially and/or downwardly out of the anchoring section.

In order to make this possible, the one or more anchoring elements may, for example, each be formed as a rope, hose, injection hose, tube or the like. In this way, the one or more anchoring elements may, for example, be arranged around the tower as far as possible in a circumferential direction, possibly in a spiral. In particular for this case, the one or more anchoring elements may optionally be filled with a filling material (e.g. a mass). Such a filling material is for example a cement grout, a cement suspension, bentonite, or a combination thereof. Through openings (e.g., holes in the tubing) arranged in the one or more anchoring elements, the filling material can escape from the openings after water saturation and penetrate into the surrounding (sea) soil where it expands and/or hardens. This reinforces, for example, a foundation of the foundation.

Such filling material is provided, for example, with reactive aggregates which propagate, for example, an ettringite, sulphate or alkali-silica driving, to name but a few non-limiting examples. Furthermore, filling material with portions of CSA (calcium sulfoaluminate) cements, for example, is suitable.

An exemplary embodiment according to all aspects of the present invention provides that the filler material is provided with such reactive additives that delay curing and/or expansion of the coating.

Such reactive aggregates propagate, for example, a drift, e.g. of water, so that hardening (or solidification) and/or expansion of the filling material after contact with a liquid (e.g. water) is noticeably delayed. Thus, initially the foundation may fully penetrate the seabed, and after the foundation reaches its final depth or depth, hardening and/or expansion occurs. As a result, this curing and/or expanding increases the strength and/or torsional strength with which the foundation is held in the seabed.

In an exemplary embodiment of the subject-matter according to all aspects, the one or more anchoring elements are each formed as a sheet, hollow section, solid section, tube, or a combination thereof.

For example, an anchoring element (of exemplary multiple anchoring elements) is formed as a push plate; fin; tube wound, for example, spirally around the anchoring section; hollow section; solid section; or other geometric body.

For example, the one or more anchoring elements are arranged with their respective longitudinal axis radial to the anchoring section (e.g., welded or otherwise attached to the shell surface (inner and/or outer) of the anchoring section) so that they provide additional resistance to rotational movement of the offshore structure or tower relative to the foundation and/or seabed.

The one or more anchoring elements are, for example, in the form of radial spikes which are, for example, extendable, to name but one further non-limiting example.

In principle, such geometries are particularly suitable as anchoring elements which can be connected to the anchoring section of the structure before the foundation is installed in the seabed, and which then do not interfere with the placement (e.g. ramming or vibrating) of the foundation.

In an exemplary embodiment of the subject matter according to all aspects, at least three anchoring elements are comprised by the foundation.

Further, the present foundation comprises, for example, at least four, five, six, seven, eight, nine, ten, eleven, twelve, or more anchoring elements.

Essentially, the one or more anchoring elements are equally spaced from each other (i.e., equally distributed), or are equally spaced from each other and/or from each other.

In an exemplary embodiment of the subject-matter according to all aspects, the one or more anchoring elements are fixedly connected to the anchoring section of the tower.

The term “fixed” as used in the subject matter is particularly understood to mean a non-detachable or detachable connection between the one or more anchoring elements and the anchoring section. Examples of such a non-detachable connection include, for example, welding, grouting, riveting, or gluing. Examples of such a releasable connection include, but are not limited to, bolting, or jamming.

In an exemplary embodiment of the subject matter according to all aspects, the foundation further comprises a plate-like element that rests on the seabed when the foundation is in an installed state and is in particular frictionally connected to the tower.

The plate-like element is, for example, a ring plate. Such a ring plate is arranged or applied as close as possible to the (sea) ground. Such a ring plate is for example in contact with the (sea) ground. Such a ring plate has, for example, a scour-reducing effect. Such a ring plate is for example connected to the tower (e.g. a pile). Such a ring plate includes, for example, at least one eccentric torsional anchoring with the (sea) ground, for example in the form of one or more small piles. Such a ring plate is, for example, fixedly connected to the tower, e.g. welded, bolted, or the like, to name but a few non-limiting examples.

When the tower is tilted, the anchoring section of the tower engaging the seabed is movable in the seabed.

Tilted positions are caused, for example, by a tidal range of the sea state prevailing in the offshore area, to name just one non-limiting example.

Tilted positions of the tower are considered as such within the meaning of the subject matter in particular if the longitudinal extension direction of the tower is outside an axis which is (e.g. exactly) vertical.

In order to avoid or compensate for extreme tilted positions in the short and long term, the foundation may comprise, for example, at least one restoring element, such as spring and/or damper elements, flexible anchorages (e.g. cable anchorages), or a combination thereof, to name but a few non-limiting examples. The at least one restoring element may provide a force counteracting a tilted position of the tower, such that the tower is (re)erected after a tilted position at least partially based on this force.

Such a tilted position may cause the anchoring section to move within the seabed. Accordingly, the anchoring section may move, for example, in the direction of two degrees of freedom within the seabed. The movement in the direction of the two degrees of freedom is, for example, within a substantially horizontal plane. In the case of a tilted position of the tower, for example caused by a tilting of the tower, such a movement of the anchoring section of the tower may take place in at least one direction within these two degrees of freedom. Further, the anchoring section of the tower may for example comprise one or more holes through which at least parts of the seabed may flow or pass when the anchoring section moves in the seabed. It will be understood that in this case the seabed has a soft structure (e.g. due to water saturation), so that accordingly at least parts of the seabed can pass through the formed hole or holes in the anchoring section.

In an exemplary embodiment of the subject-matter according to all aspects, an upper section of the tower is movable relative to the anchoring section of the tower, wherein when the tower is tilted, the anchoring section remains substantially in position in the seabed.

Between the upper section and the anchoring section of the tower, for example, a foundation joint is formed. This foundation joint may, for example, be spring-loaded and/or damped, for example by means of appropriately arranged spring and/or damping elements or elements encompassed by the foundation joint, which stiffen the tilt stability of the tower. Such spring and/or damping elements may form at least one restoring element in the sense of the subject-matter.

The upper portion of the tower is movable relative to the anchoring section of the tower, for example, in the direction of at least two degrees of freedom, such as for tilting the tower in the direction of a horizontal plane of the substantially vertically disposed tower.

In an exemplary embodiment of the subject-matter according to all aspects, the upper section of the tower is substantially torsionally stiff and/or torsionally force transmitting supported in the anchoring section of the tower.

If the anchoring section is designed in such a way that it accommodates a further cylindrical hollow body which is mounted within the outer cylinder in such a way that the centre of rotation lies at least below a height (which in turn lies, for example, about 5 m above the seabed), it is provided for example that its mounting is designed to be largely torsionally rigid or stiff and/or torsionally force-transmitting in the sense of the subject-matter. This attribute can then be transferred from the anchoring section to the inner hollow body, for example.

In an exemplary embodiment of the subject-matter according to all aspects, the upper section of the tower is at least partially movably supported within and within a receiving region of the anchoring section of the tower, wherein a formed space between the receiving region of the anchoring section and the upper section of the tower is filled with a filler material.

The movable mounting of the upper section of the tower in the receiving region of the anchoring section of the tower, in which the upper section of the tower is receivable, is realized for example by means of a formed foundation joint. As already described above, this foundation joint may, for example, be spring-loaded and/or damped, for example by means of one or more spring and/or damping elements arranged accordingly or comprised by the foundation joint.

Alternatively or additionally, for example, at the level of a pivot point below the surrounding sea surface, a joint is arranged (e.g. installed) within the surrounding tower (e.g. pile) which transmits torsional forces into the outer anchoring section (e.g. outer pile), for example, either directly or into the (sea) bottom located in the pile or below the pile or via this (sea) bottom into the pile.

For example, this joint is either firmly and frictionally connected, e.g. welded or grouted, or hydrostatically connected to the outer anchoring section of the tower (e.g. outer pile). Alternatively or additionally, the pivot bearing may, for example, be connected to the seabed in a planar manner or by (e.g. smaller) piles, barrels, or the like.

Alternatively or additionally, the section engaging the anchoring section (upper section of the tower) may further be fixed, for example, by chains, anchor cables or the like, to name but a few non-limiting examples.

In an exemplary embodiment of the subject-matter according to all aspects, the filler material is or comprises an elastomer.

This is achieved, for example, by arranging in the annulus (for example, the space between a drill string or casing and a surrounding formation), presently between the inner, i.e. upper, section of the tower and the outer, i.e. anchoring, section of the tower (e.g., inner and outer cylinders in the case of a pile), a cylinder filling the intermediate space and/or a filler material, for example, comprising or consisting of an elastomer.

In an exemplary embodiment of the subject-matter according to all aspects, the anchoring section of the tower is formed substantially with a base surface different from a circular base surface at least at its end engaging the seabed, in particular with an oval-shaped, rectangular, square, polygonal or semicircular base surface.

For example, the end of the anchoring section that engages or penetrates the seabed is oval-shaped, for example in contrast to the upper section of the tower, or the tower transitions from the upper section to the anchoring section to an oval shape.

Alternatively or additionally, a cylindrical cross-section of the anchoring section in the lower region thereof is, for example, no longer formed as a fully symmetrical body of revolution, i.e. in the lower section the last extension is continued, for example, only by a half cylinder.

The exemplary embodiments of the present invention previously described in this description are also to be understood as disclosed in all combinations with each other. In particular, exemplary embodiments are to be understood as disclosed with respect to the various aspects.

In particular, by the previous or following description of method steps according to preferred embodiments of a method, corresponding means for carrying out the method steps by preferred embodiments of an apparatus shall also be disclosed. Likewise, by disclosing means of an apparatus for carrying out a method step, the corresponding method step shall also be disclosed.

Further advantageous exemplary embodiments of the invention will be found in the following detailed description of some exemplary embodiments of the present invention, particularly in connection with the figures. However, the figures are intended only for the purpose of clarification and not for determining the scope of protection of the invention. The figures are not to scale and are merely intended to reflect the general concept of the present invention by way of example. In particular, features included in the figures are in no way intended to be considered a necessary part of the present invention.

### BRIEF DESCRIPTION OF THE DRAWINGS

In the drawing shows

FIG. 1 schematic representation of an offshore structure comprising a present foundation;

FIG. 2 another schematic sectional view of an offshore structure comprising a present foundation;

FIG. 3a-d a respective schematic sectional representation of exemplary embodiments of present anchoring elements; and

FIG. 4 a frequency spectrum diagram.

### DESCRIPTION OF THE INVENTION

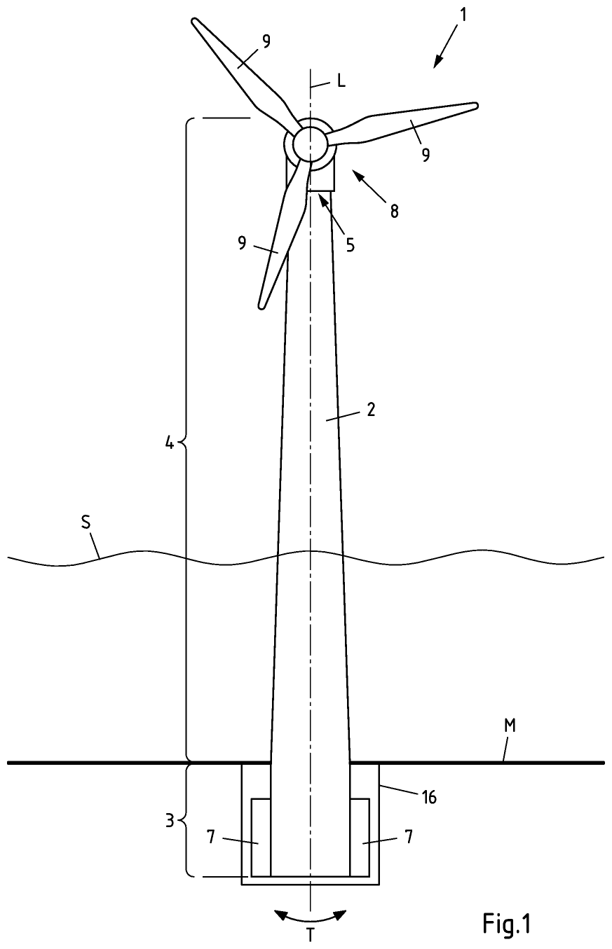

FIG. 1 shows a schematic representation of an offshore structure 1, which is at least partially founded on or in the seabed M by means of a present foundation.

The offshore structure 1 is in the present case an offshore wind turbines comprising a tower 2 having at its upper end an electricity generation device 8 (e.g. a turbine, not shown in the schematic drawing according to FIG. 1) with three exciting components, in the present case three rotor blades 9. At the upper end of the tower 2, for example, a connection section 5 (e.g. a flange connection) is formed in order to arrange, for example, the schematically illustrated electricity generation device 8 on the tower 2.

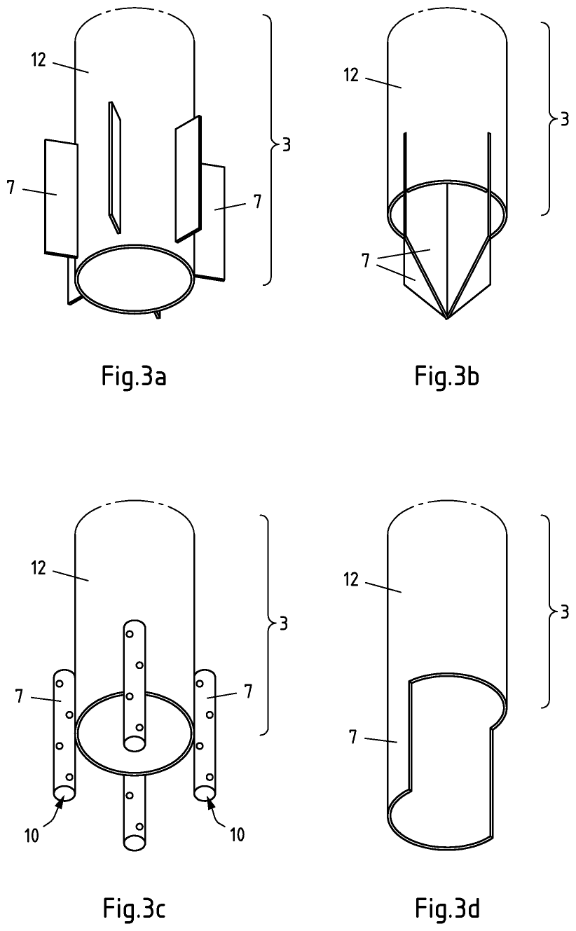

The tower 2 is divided into an anchoring section 3 and an overlying upper section 4. In the present case, the anchoring section 3 is anchored in the seabed M or at least partially engages therein. Furthermore, the tower 2 or the anchoring section 3 comprises anchoring elements 7, which are presently formed as metal sheets and project radially or laterally from the outer wall of the anchoring section 3 into the seabed substantially in a horizontal direction. These can be formed alternatively or additionally to the embodiments shown in FIGS. 3a-d.

Optionally, the anchoring section 3 engaging the seabed M comprises an outer anchoring element 16 at least partially enclosing the seabed M. The anchoring section 3 is, for example, partially insertable or presently inserted into this outer anchoring element 16. Torsional forces T may then be transferable or presently transferred from the inner part to the outer anchoring element 16, for example.

The offshore structure 1, which is founded with a present foundation 1, has a natural frequency below an excitation from a single revolution number 1P from the three rotor blades 9 of the electricity generation device.

The design of the low natural frequency of the offshore structure 1 is made possible by the fact that the offshore structure 1 is anchored in the seabed M with a lower embedment depth.

The anchoring elements 7 counteract a torsional force which runs or acts radially around the longitudinal extension direction L of the tower 2 shown schematically in FIG. 1.

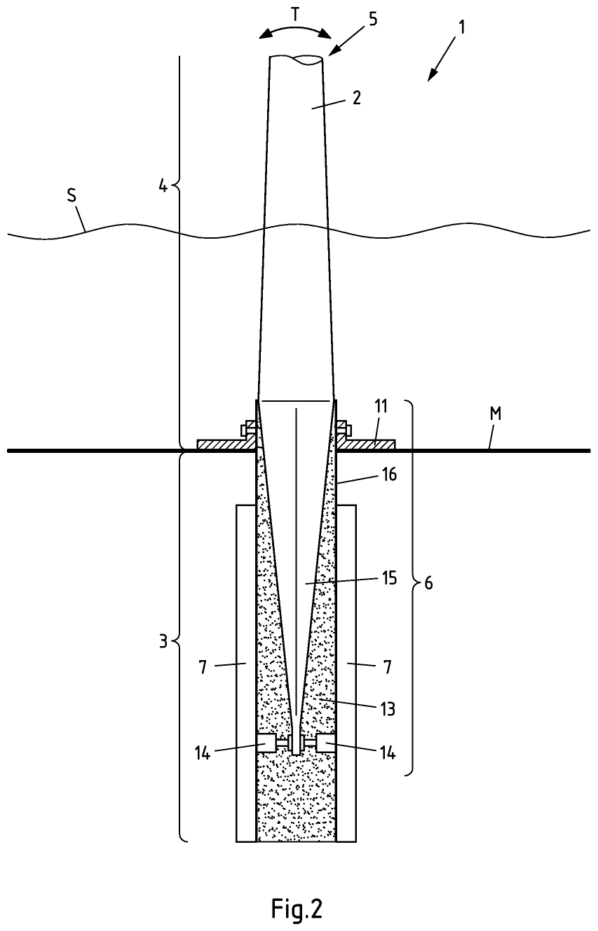

FIG. 2 shows another schematic sectional view of an offshore structure 1, wherein an upper portion 4 of the tower 2 of the offshore structure 1 is movable in the direction of at least two degrees of freedom within the anchoring section 3 of the tower 2. At the upper end of the tower 2, for example, a connection section 5 (e.g. a flange connection) is formed for arranging, for example, an electricity generation device 8 (not shown in FIG. 2) on the tower 2.

The upper section 4 of the tower 2 engages, by means of a conically tapering (inner) connection section 15 surrounded by the latter, in a receiving region 6 of the anchoring section 3. For this purpose, the anchoring section 3 comprises in the present case an outer anchoring element 16. The intermediate space formed between the inner connecting section 15 and the outer anchoring element 16 may, for example, be filled (illustrated schematically by means of the dotted area), for example with an elastic filling material 13, such as an elastomer, polymer, sand-clay, sand-clay mixture, to name but a few non-limiting examples.

Furthermore, the anchoring section 3 of the tower 2 comprises optional damper and spring elements 14 which act as restoring elements. The damper and spring elements 14 cause, for example, a tilted position of the tower 2, wherein the upper section 4 is tilted relative to the anchoring section 3, to be damped or sprung. Furthermore, by means of the optional damper and spring elements 14, a restoring tensile and/or compressive force can be effected in case of a tilted position of the upper section 4 of the tower 2, which can lead to an erection of the upper section 4 of the tower 2 after a tilted position of the upper section 4 of the tower has been effected.

The anchoring section 3 of the tower 2 may be open towards the bottom, as designed in the present case, so that anchoring of the anchoring section 3 in the seabed M can be safely effected.

Analogous to the offshore structure 1 of FIG. 1, the exemplary embodiment of a foundation illustrated in FIG. 2 also has anchoring elements 7 at the anchoring section. These can be designed analogously to the shown anchoring elements 7 of FIG. 1.

It is understood that both the anchoring elements 7 of FIG. 1 and the anchoring elements 7 of FIG. 2 may also be formed according to one or more of the embodiments shown in FIGS. 3a-d.

The anchoring section 3 of the tower 2 may, for example, form a so-called cofferdam in which a pile (the upper section 4 of the tower 2) is then at least partially arranged. A rotation of the upper section 4 of the tower 2 may then, for example, be restrained in such a way that the upper section 4 of the tower 2 cannot rotate within the excavated cofferdam or the anchoring section 3 of the tower 2. Alternatively, such an anchoring section may comprise a dynamic joint which also realizes the functions described above. Then, for example, torsional forces T occurring from, for example, the upper section 4 of the tower 2 formed as an inner pile are transmitted via such a joint to the anchoring section 3 of the tower 2 formed as an outer pile.

The foundation of FIG. 2 further comprises a plate-like element 11 which, in the arranged state of the foundation (i.e., for example, after its installation in the seabed M), substantially (in particular directly) rests on the seabed M and, in particular, is non-positively connected to the tower 2. In the present case, this connection is implemented via a screw connection of the plate-like element 11 to the tower 2.

In the present case, the plate-like element 11 is a ring plate which completely surrounds the tower 2. The plate-like element 11 has, for example, a scour-reducing effect. The plate-like element 11 may comprise one or more additional elements (e.g. piles) extending vertically into the seabed M from the plate-like element 11 (not shown in FIG. 2). This may further increase the torsional strength and/or torsional stiffness.

FIGS. 3a-d each show a schematic sectional representation of exemplary embodiments of present anchoring elements which can be used, for example, as anchoring elements on one of the foundations shown in FIGS. 1 and 2, instead of or in addition to the anchoring elements 7 formed as metal sheets.

Such anchoring elements are also referred to as torsion anchors, or torsion foundation anchors, in the sense of the subject matter.

The anchoring elements 7 of FIGS. 3a-d may, for example, either be arranged (e.g. welded or screwed on, to name but a few non-limiting examples) at the corresponding anchoring section already ex factory, i.e. during the manufacture of at least a section of the tower of a present foundation. Alternatively or additionally, one or more of these anchoring elements may be arranged offshore (or at a quay edge) only during installation of a present foundation. In the latter case, this may, for example, include appropriate support plates.

FIG. 3a shows anchoring elements 7, which in the present case are arranged on an anchoring section 3 having a circular base surface 12. Each of the anchoring elements 7 is arranged on the outer surface of the anchoring section 3. The anchoring elements 7 each have an identical spacing from one another.

FIG. 3b shows anchoring elements 7, which in the present case are arranged on an inner surface of the anchoring section 3. The anchoring elements protrude beyond the end of the anchoring section 3 that is lowest after installation. The anchoring elements 7 form a cross-shaped structure, and moreover a pointed structure which can facilitate, for example, the insertion of the foundation or the anchoring section 3 into the seabed. The anchoring section 3 shown in FIG. 3b also has a circular base 12.

FIG. 3c shows anchoring elements 7, which are presently arranged on an outer surface of the anchoring section 3. In the present case, the anchoring elements 7 are each tubular, for example in the form of small stakes. The anchoring elements 7 each have openings, for example holes. The anchoring elements 7 are hollow on the inside, so that they can be filled with a reactive material 10. After contact with water or water saturation, e.g. after insertion of the anchoring section 3 into the seabed, this reactive material 10 can escape from the openings, e.g. expand and subsequently harden. This increases, for example, the strength of the foundation in the seabed.

FIG. 3d shows an anchoring element 7 comprised by the anchoring section 3, extending it in a semicircular shape.

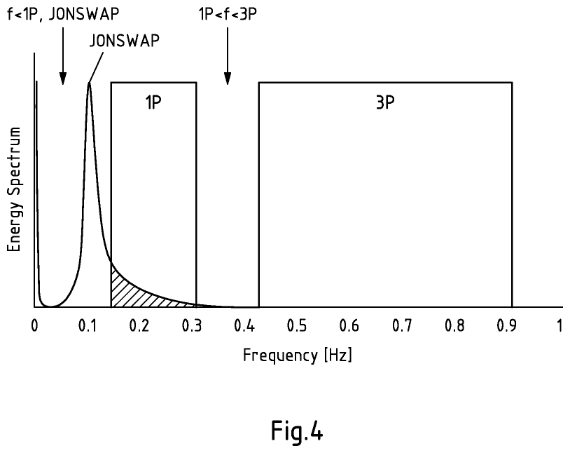

FIG. 4 shows a frequency spectrum diagram in which excitation frequencies are shown during operation of a wind turbine.

As already described, for the determination of a natural frequency of an overall system (offshore structure, in particular wind turbine) consisting of a foundation consisting of a tower and a power generation device (e.g. with one or more rotor blades), ranges within a frequency spectrum can be defined in advance in which the natural frequency should lie.

For example, a wind turbine experiences a (dynamic) excitation during operation, in particular from wind loads, from a periodic excitation with the single number of revolutions (rotor frequency, 1P excitation; for example, caused by imbalances that occur during the rotation of the rotor blades), as well as from a further periodic excitation from the rotor blade passage with three times a number of revolutions (3P excitation; for example, by an inflow of wind to the rotor blade, whereby the rotor blade is located directly in front of the tower).

Furthermore, FIG. 4 shows the so-called JONSWAP spectrum, which represents the wave energy spectrum due to the sea state in offshore structures and which can also cause excitation of the offshore structure.

The closer the natural frequency of the wind turbine is to these exciting frequencies, the higher the stress on the mechanical components and the tower can be.

If the first natural frequency of the offshore structure is below the frequency from three times the rotor revolution number 3P, the design of the offshore structure is referred to as “soft-stiff”. If the design of the offshore structure is also above the frequency from three times the rotor revolution number 3P, the design is also referred to as “stiff-stiff”. If, on the other hand, the first natural frequency of the offshore structure is below the frequency from the single rotor revolution number 1P, the design is referred to as “soft-soft”.

It is understood that when designing the natural frequency of an offshore structure, a natural frequency design that is within the 1P and/or 3P frequency band should be avoided to prevent premature material fatigue and wear.

The embodiments of the present invention described in this specification and the optional features and characteristics indicated in each case with respect thereto are also intended to be understood as disclosed in all combinations with each other. In particular, the description of a feature encompassed by an embodiment example—unless explicitly stated to the contrary—is also not to be understood herein as meaning that the feature is indispensable or essential for the function of the embodiment example. The sequence of the process steps described in this specification in the individual flowcharts is not mandatory, alternative sequences of the process steps are conceivable. The process steps can be implemented in various ways, for example, implementation in software (by program instructions), hardware or a combination of both is conceivable for implementing the process steps.

Terms used in the patent claims such as “comprising”, “having”, “including”, “containing” and the like do not exclude further elements or steps. The phrase “at least in part” includes both the case “in part” and the case “in full”. The phrase “and/or” is intended to be understood to disclose both the alternative and the combination, so “A and/or B” means “(A) or (B) or (A and B)”. The use of the indefinite article does not preclude a plurality. A single device may perform the functions of multiple units or devices recited in the claims. Reference signs indicated in the patent claims are not to be considered as limitations of the means and steps employed.

### LIST OF REFERENCE SIGNS

1 Offshore structure

2 Tower

3 Anchoring section

4 Upper section

5 Connection section

6 Receiving region of the anchoring section

7 Anchoring element

8 Electricity generation device

9 Rotor blade

10 Reactive material

11 plate-like element

12 Base surface

13 Filling material

14 Restoring element

15 inner anchoring section

16 external anchoring element

M Seabed

S Water surface

L Longitudinal direction of the tower

T Torsion force

1. An offshore structure, comprising:
a tower having an anchoring section which is anchorable in the seabed and a connection section arranged at the opposite end of the tower, and an electricity generation device arranged and connected with the connection section of the tower above the water surface;
wherein a natural frequency of the offshore structure is below an excitation from a single revolution number 1P of at least one exciting component;
wherein
the anchoring section engaging the seabed has one or more anchoring elements which counteract a torsional force about an axis in the longitudinal direction of the tower;
wherein
in a tilted position of the tower the anchoring section of the tower engaging the seabed is movable in the seabed.

2. The offshore structure according to claim 1, wherein the anchoring section engaging the seabed comprises an inner anchoring section and an outer anchoring element at least partially enclosing the inner anchoring section, wherein the inner anchoring section is insertable into the outer anchoring element, and wherein one or more torsional forces are transmittable from the inner anchoring section to the outer anchoring element.

3. The offshore structure according to claim 1, wherein the one or more anchoring elements protrude radially inwardly and/or outwardly from an inner and/or outer surface of the anchoring section.

4. The offshore structure according to claim 1, wherein the one or more anchoring elements extend substantially in the longitudinal extension direction of the tower beyond the seabed-engaging end of the anchoring section into the seabed.

5. The offshore structure according to claim 1, wherein the one or more anchoring elements comprise a reactive material or are filled with a reactive material.

6. The offshore structure according to claim 5, wherein in the course of installation of the foundation the reactive material hardens and/or expands after water saturation, and/or in the course of installation of the foundation expands radially and/or downwardly out of the anchoring section.

7. The offshore structure according to claim 1, wherein the one or more anchoring elements are each formed as sheet metal, hollow section, solid section, tube, or a combination thereof.

8. The offshore structure according to claim 1, wherein at least three anchoring elements are comprised by the foundation.

9. The offshore structure according to claim 1, wherein the one or more anchoring elements are fixedly connected to the anchoring section of the tower.

10. The offshore structure according to claim 1, wherein the foundation further comprises a plate-like element which, in the arranged state of the foundation, rests on the seabed and is in particular frictionally connected to the tower.

11. (canceled)

12. The offshore structure according to claim 1, wherein an upper section of the tower is movable relative to the anchoring section of the tower, wherein when the tower is tilted, the anchoring section in the seabed remains substantially in position.

13. The offshore structure according to claim 12, wherein the upper section of the tower is substantially torsionally stiff and/or torsionally force transmitting supported in the anchoring section of the tower.

14. The offshore structure according to claim 12, wherein the upper section of the tower is at least partially movably supported within and in a receiving region of the anchoring section of the tower, wherein a formed space between the receiving region of the anchoring section and the upper section of the tower is filled with a filling material.

15. The offshore structure of claim 14, wherein the filler material is or comprises an elastomer.

16. The offshore structure according to claim 1, wherein the anchoring section of the tower, at least at its end engaging the seabed, is substantially formed with a base surface deviating from a circular base surface, in particular is formed with an oval-shaped, rectangular, square, polygonal or semicircular base surface.

17. (canceled)
